(19) United States
(12) Patent Application Publication
(10) Pub. No.: US 2001/0045718 A1
(43) Pub. Date: Nov. 29, 2001

(54) Multiple function job site work cart

(76) Inventor: Ron P. Boirum, Niland, CA (US)

Correspondence Address: WEISS & MOY PC, 4204 NORTH BROWN AVENUE, SCOTTSDALE, AZ, 85251, US

(21) Appl. No.: 09/860,399

(22) Filed: May 18, 2001

Related U.S. Application Data
(60) Provisional application No. 60/205,330, filed on May 18, 2000.

(51) Int. Cl. B62B 1/10; B62B 3/00

(52) U.S. Cl. 280/47.26; 280/638; 280/79.11

(57) ABSTRACT

A multiple function job site work cart in which the basic component is a wheel-based cart having a base, two opposing sides perpendicular to the base, and capable of being rolled in a horizontal or vertical orientation. With the incorporation of additional components including dividers, steps, a door, frames, outriggers, stabilizing bars, brackets, and others, the cart can be configured as a materials cart, wheelbarrow, storage cart, scaffold, ladder, dolly, sheet support, and other structures useful in a work setting. When not in use, the components can be packed into or coupled to the car for storage and/or transport.

### RELATED APPLICATIONS

This non-provisional application claims priority from provisional application No. 60/205,330, filed on May 18, 2000.

### BACKGROUND OF THE INVENTION

1. Field of Invention

This invention relates generally to apparatuses used on a construction job site and, more specifically, to a multiple function job site work cart.

2. Description of the Related Art

Persons working on a construction site require the use of a number of different apparatuses during the construction process. For example, materials carts and wheelbarrows are needed to transport items on the job site, a storage box is needed to store tools and the like in a secure manner, and ladders and scaffolds are needed to access the structure being built.

Currently, these apparatuses are discrete; i.e., they tend to perform only one function. Thus, a wheelbarrow would not also be useable as a ladder, scaffold, storage box, etc. As a result, there is generally a need to acquire a separate apparatus to perform each desired function. As a result, these many apparatuses can be relatively costly and can take up a relatively large amount of space, making them relatively unportable as a group.

A need therefore existed for a job site apparatus capable of performing multiple functions, including preferably that of materials cart, wheelbarrow, storage box, ladder, scaffold, and others. The multiple function apparatus should be portable, both within the job site and so as to be movable from one job site to another. The present invention satisfies these needs and provides other, related, advantages.

### SUMMARY OF THE INVENTION

It is an object of the present invention to provide a job site apparatus capable of performing multiple functions.

It is a further object of the present invention to provide a job site apparatus capable of serving as a number of different apparatuses useable on a job site, including that of materials cart, wheelbarrow, storage box, ladder, scaffold, and others.

It is a still further object of the present invention to provide a portable job site apparatus capable of serving as a number of different apparatuses useable on a job site.

The foregoing and other objects, features, and advantages of the invention will be apparent from the following, more particular, description of the preferred embodiments of the invention, as illustrated in the accompanying drawings.

### BRIEF DESCRIPTION OF THE PREFERRED EMBODIMENTS

In accordance with one embodiment of the present invention, a multiple function work cart is disclosed. It comprises, in combination: a cart having a base and two opposing side walls coupled at a right angle to the base so as to form an essentially U-shaped structure when viewed from an end thereof having two open ends; wheels coupled to the cart; and dividers adapted to be removably coupled to at least one of the open ends.

In accordance with another embodiment of the present invention, a multiple function work cart is disclosed. It comprises, in combination: a cart having a base and two opposing side walls coupled at a right angle to the base so as to form an essentially U-shaped structure when viewed from an end thereof having two open ends; wheels coupled to the cart; wherein the wheels comprise two wheels located proximate a first end of the base, two wheels located proximate a second end of the base, and one wheel located proximate a top portion of each the side wall so that the cart may optionally be rolled in each of a horizontal and vertical configuration; dividers adapted to be removably coupled to at least one of the open ends; means for removably coupling handles to the cart; a door adapted to be hingedly coupled to one of the side walls opposite the base; at least two ladder-shaped frame member comprising two vertical members joined by at least one horizontal member and wherein an end portion of the vertical members is adapted to be removably coupled to the cart proximate corner portions of the side walls; at least one step adapted to be positioned across the horizontal members of the two ladder-shaped frame members when in position on opposing ends of the cart; and a coupling member adapted to permit the coupling of two ladder-shaped frame members in a vertical direction so that one the ladder-shaped frame member is positioned directly on top of another.

In accordance with yet another embodiment of the present invention, a multiple function work cart is disclosed. It comprises, in combination: a cart having a base and two opposing side walls coupled at a right angle to the base so as to form an essentially U-shaped structure when viewed from an end thereof; two wheels located proximate a first end of the base; two wheels located proximate a second end of the base; and one wheel located proximate a top portion of each the side wall so that the cart may optionally be rolled in each of a horizontal and vertical configuration.

### BRIEF DESCRIPTION OF THE DRAWINGS

FIG. 1 is a perspective view of the multiple function job site work cart of the present invention, in a horizontal orientation.

FIG. 1A is a side view of the multiple function job site work cart of the present invention, configured as a wheelbarrow.

FIG. 2 is a perspective view of the multiple function job site work cart of the present invention, in a vertical orientation.

FIG. 2A is a perspective view of the multiple function job site work cart of the present invention in a vertical orientation and in use as a step ladder.

FIG. 2B is a perspective view of the multiple function job site work cart of the present invention in a vertical orientation and with a door thereon, in use as a storage box.

FIG. 3 is a perspective view of the multiple function job site work cart of the present invention configured for storage and transport.

FIG. 4 is a perspective, partially exploded view of the frame storage portion of the multiple function job site work cart of the present invention.

FIG. 5 is a perspective view of the multiple function job site work cart of the present invention configured as a scaffold.

FIG. 5A is a perspective view of a frame joining member.

FIG. 6 is a perspective view of a portion of the multiple function job site work cart of the present invention when configured as a scaffold, illustrating the positioning of a work table thereon.

FIG. 6A is a perspective view of a stabilizing bar.

FIG. 7 is a perspective view of the multiple function job site work cart of the present invention, when configured to position plastic sheeting or the like proximate a work area.

FIG. 8 is a perspective view of a walkway.

FIG. 8A is a perspective view of a support member for the walkway of FIG. 8.

FIG. 9 is a perspective view of the multiple function job site work cart of the present invention, illustrating the use of the walkway of FIG. 8 in combination with the work cart configured as a scaffold.

FIG. 10 is a perspective view of a ladder formed using frame member portions useable with the work cart of the present invention.

### DETAILED DESCRIPTION OF THE PREFERRED EMBODIMENTS

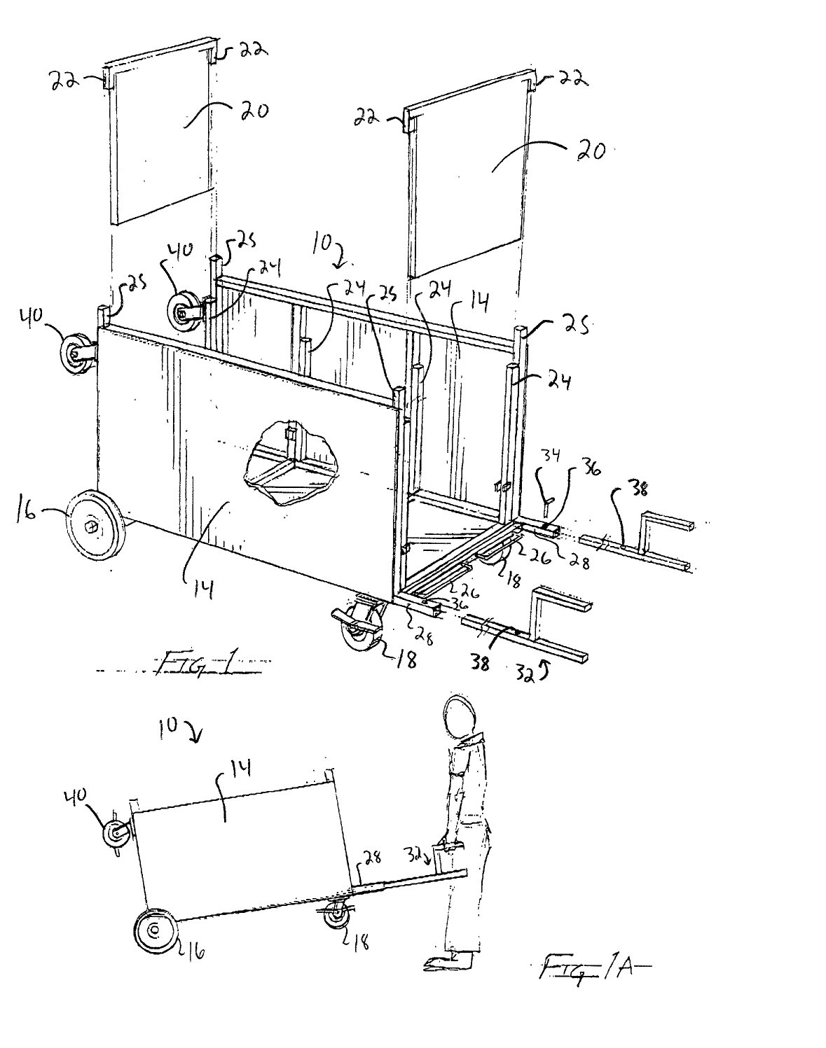

Referring first to FIG. 1, the multiple function job site work cart 10 (hereinafter “cart 10”) of the present invention is shown, in its most basic configuration. In the configuration shown in FIG. 1, the cart 10 can be seen to comprise, when in a horizontal orientation, a base 12 and two opposing rectangular side walls 14 perpendicular to the base 12. Each of the base 12 and side walls 14 are preferably formed by welding sheet metal over a steel frame. Portability is imparted to the cart 10 in its horizontal orientation by large wheels 16 located at a first end of base 12 and small wheels 18 located at a second end of base 12. Small wheels 18 are preferably pivoting, so as to impart maneuverability to the cart 10, and locking, so as to permit the cart 10 to be secured in a desired location.

The cart 10 in the configuration shown in FIG. 1 can serve as a materials cart. Thus, materials can be placed within the space defined by the base 12 and side walls 14, and moved around the job site with the user grasping one or both side walls 14 and pushing or pulling the cart 10 in the desired direction. (The cart 10 could also be maneuvered by inserting one or more Y-shaped brackets 32, described below, into corner receiving shafts 25, also described below.) Because both ends of the cart 10 between the side walls 14 are open, the cart 10 could particularly efficiently be used to transport oversized items such as 2×4's, which can project out one or both sides of the cart 10.

Still referring to FIG. 1, it can be seen that dividers 20 can be positioned in one or both open ends of the cart 10, between side walls 14. Coupling of the dividers 20 to ends of the cart 10 is accomplished by positioning L-shaped insertion shafts 22 projecting from sides of the dividers 20 into receiving shafts 24 located at end portions of the side walls 14 and at two other points along the length of the side walls 14. (As shown in FIG. 1, the receiving shafts 24 are preferably adjacent the steel frame members on the side walls 14 that run perpendicular to the base 12.) When dividers 20 are positioned in the receiving shafts 24 at both ends of the cart 10, it takes on the orientation of a closed-end materials cart or wheel barrow.

It can be seen that permanent handles 26 are positioned at an end of the base 12 on the same side of the base 12 as the large wheels 16, and project outward from the base 12. When using the cart 10 as a wheel barrow, a user can, optionally, grasp the permanent handles 26 and lift an end of the cart 10 off of the ground, so that only the large wheels 16 are contacting the ground. (It should be noted that when a divider 20 is positioned only in the end of the cart 10 proximate the large wheels 16, it takes on the orientation of a materials cart or wheel barrow in which oversized materials can be transported at an angle with the user grasping the permanent handles 26 and lifting an end of the cart 10—so that the materials will contact the divider 20 on one side and may project outward from the cart 10 in the direction of the user on the other.)

Referring now to FIGS. 1 and 1A, located on the base 12 along both sides thereof, and opening at both ends thereof, are receiving shafts 28. Among other things, the insertion shafts 28 are dimensioned to receive the insertion shaft portion 30 of Y-shaped brackets 32. These Y-shaped brackets 32 should be inserted into the insertion shafts 28 to the desired depth, and secured at that position by the insertion of a pin 34 through an opening 36 in the insertion shaft 28 and through an aligned opening 38 in the insertion shaft portion 30 of the Y-shaped bracket 32. (Although only one is shown, the insertion shaft portion 30 preferably contains a plurality of openings 38 along the length thereof, to facilitate coupling to the insertion shaft 28 at different points so as to enable the adjustment of the position of the Y-shaped bracket 32.) As shown in FIG. 1A, when in position, the Y-shaped brackets 32 serve as handles for the cart 10, permitting it to be raised so that it travels only upon the large wheels 16 in wheelbarrow fashion.

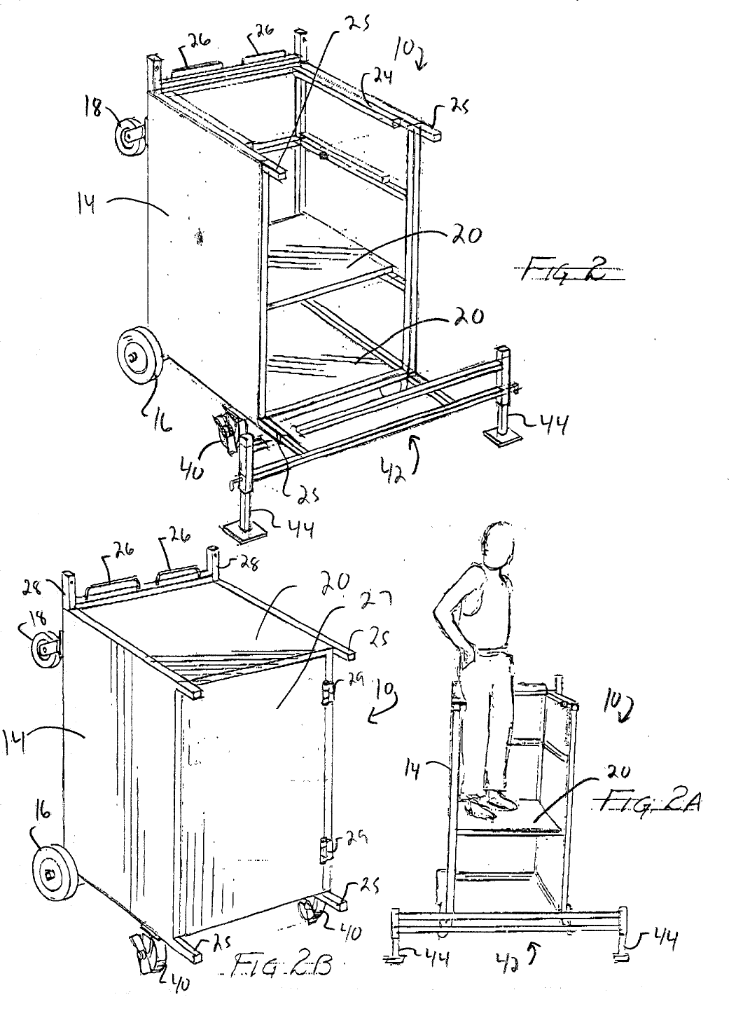

Referring now to FIGS. 2, 2A and 2B, the cart 10 is shown in a vertical orientation, positioned on the large wheels 16 and on small wheels 40, which small wheels 40 are preferably pivoting and locking. (The small wheels 40 are located proximate a top corner of side walls 14 when viewed in a horizontal orientation, and on the same end of the cart 10 as the large wheels 16.) Dividers 20 should in this orientation be positioned at least at the end of the cart 10 most proximate the ground, and dividers 20 may be placed in other receiving shafts 24 so as to form shelves or steps.

In the vertical orientation, the cart 10 can serve as a dolly (FIG. 2), as an upright storage unit (FIG. 2B), or as a step ladder (FIG. 2A). Where the cart 10 is to serve as a storage unit, it will be desired to position a door 27 to cover the open front of the upright unit, with the door 27 being hingedly coupled to one side wall 14 with hinges 29. (Preferably, each hinge 29 comprises a two-part assembly, with one part being affixed to a side wall 14 and a mating second part being affixed to the door 27—so that the door 27 can be hingedly coupled to the side wall 14 by coupling the two mating portions of the hinges 29.) In this configuration, a locking device can further be used—such as a chain locked in position around the door 27, side walls 14 and base 12—so as to provide a secure storage location for tools and the like.

Referring to FIGS. 2 and 2A, where additional stability is required, an outrigger 42 can be inserted into corner receiving shafts 25, located at each of the corners of the side walls 14 distal from the base 12. The outrigger 42 includes adjustable length legs 44. Such additional stability may especially be desired where, as shown in FIG. 2A, the cart 10 is to be used as a step ladder.

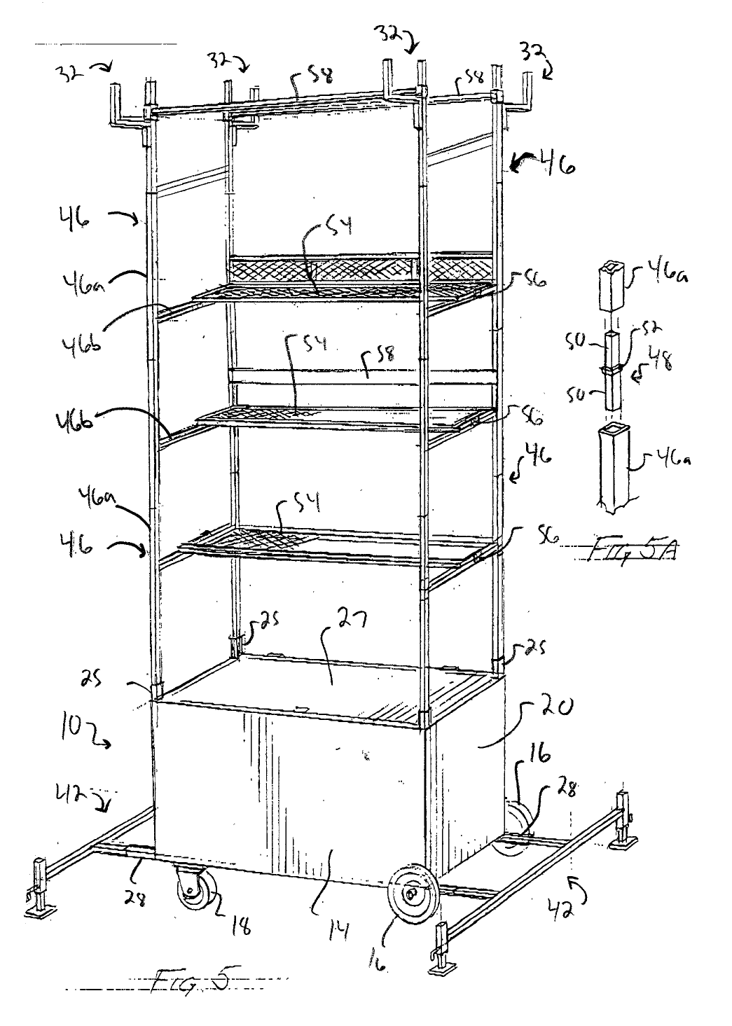

Referring now to FIGS. 4-5, several of the other basic components which may be used together with the cart 10 are illustrated. Preferably four frames 46 are provided, each having an essentially ladder configuration and consisting of two vertical members 46a connected by two horizontal members 46b therebetween (see also FIG. 5). The frames 46 are dimensioned so that end portions of the vertical members 46a may be inserted within the corner receiving shafts 25, so that the frames 46 will be perpendicular to the ground and will project upward. Referring briefly to FIG. 5A, where it is desired to couple two frames 46 vertically, a coupling device 48 is used, comprising an insertion shaft 50 adapted to be inserted into the ends of the vertical members 46a of the frame 46, which insertion shaft 50 has a stop region 52 thereon. The stop region 52 is dimensioned to be too large to be inserted into the vertical members 46a of the frame 46, and will be exposed between two frames 46 when the coupling device 48 is positioned therebetween.

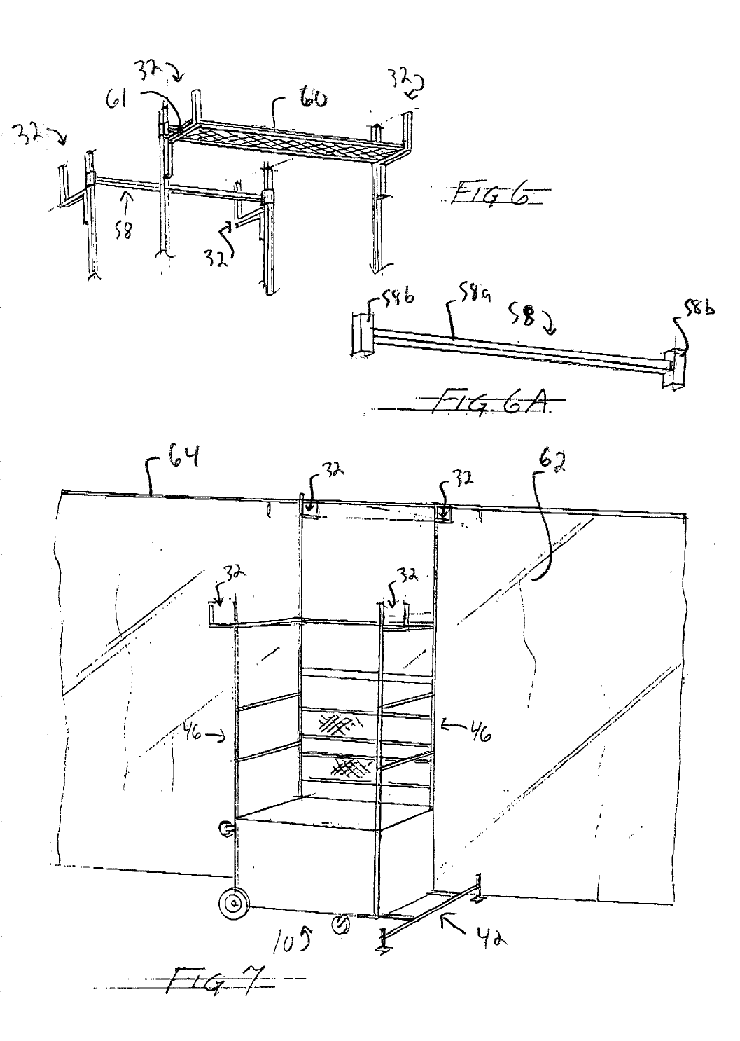

Referring now to FIG. 5, the configuration of the cart 10 as a scaffold is illustrated. In this configuration, frames 46 are inserted into receiving shafts 25 on both short sides of the cart 10. Preferably, two frames 46 are positioned on either side of the cart 10, which frames 46 are joined by the coupling devices 48. Across horizontal member portions of the frames 46 are positioned steps 54, which steps 54 are preferably rectangular-shaped and comprise a steel framed over which is positioned a mesh screen or the like. The steps 54 further comprise at least one tab 56 extending from each short side thereof, which is dimensioned to secure the step 54 relative to the horizontal member 46b of the frame 46. To provide further stability, a stabilizing bar 58 (see FIG. 6A) may be coupled across the vertical member 46a portions of two opposing frames 46. The stabilizing bar 58 comprises a horizontal bar 58a and a bracket 58b at each end of the horizontal bar 58a, which brackets 58b are dimensioned to be fitted snugly over vertical members 46a.

At a top portion, the Y-shaped brackets 32 may be inserted into the exposed ends of the vertical member 46a of the frames 46. In this position, the Y-shaped brackets 32 comprise handles useable by a person on the scaffold. Moreover, a reduced-width step 60 (with tabs 61 projecting downward from end portions thereof) may be positioned across at least one of the Y-shaped brackets 32, so as to constitute a work table for the user. A reduced-width step 60 may also be positioned, as shown in FIG. 5, at a ninety degree angle to a step 54, so as to constitute a toe board for the user. As also shown in FIG. 5, additional stability can be provided by positioning outriggers 42 at both ends of the cart 10.

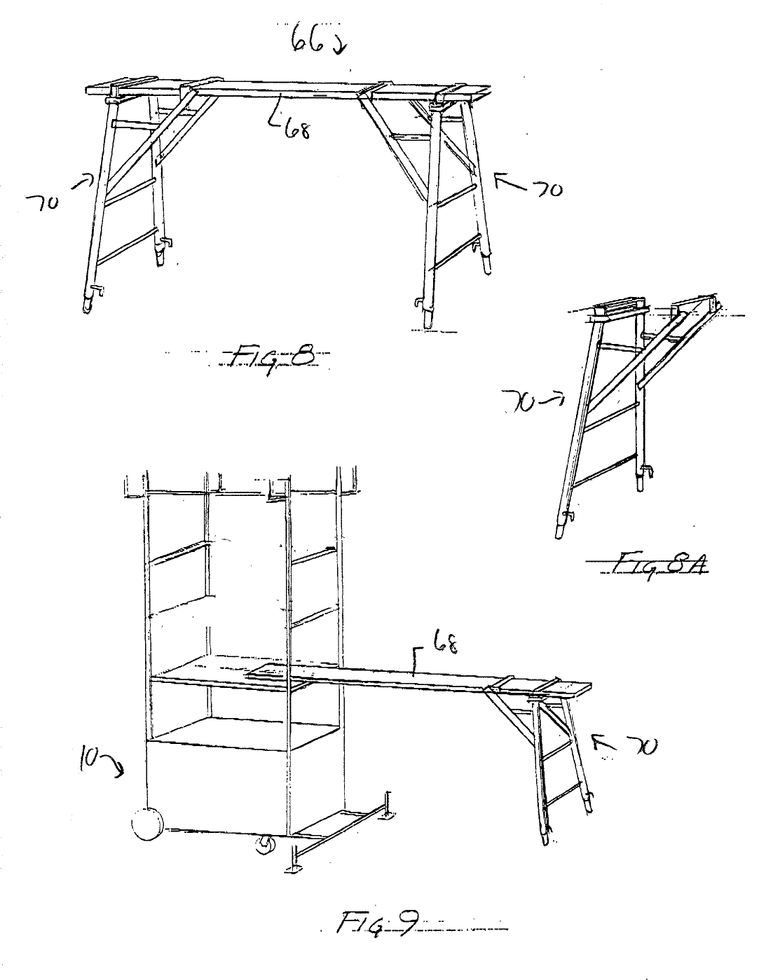

Referring now to FIG. 7, the cart 10 when configured as a scaffold can also be used to support a plastic sheet (or similar type of material) 62, which can be used to protect a work area. The sheet 62 is suspended from a bar 64, which bar 64 is preferably supported by the Y-shaped brackets 32. Additional stability can be provided by one or more outriggers 42.

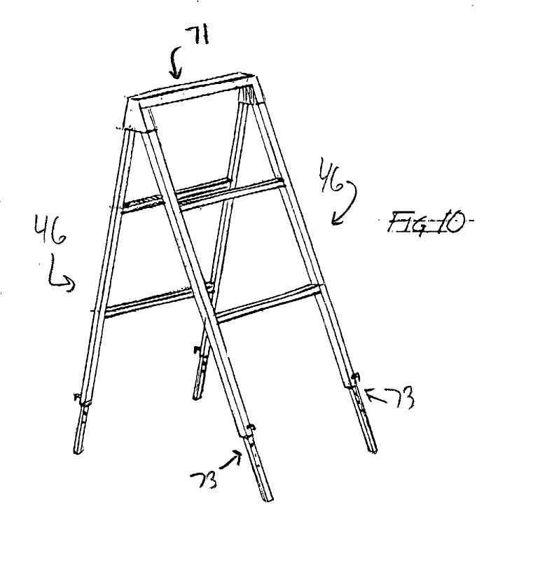

Referring now to FIGS. 8-9, the use of a walkway 66 in combination with the cart 10 is shown. Referring first to FIG. 8, the basic components of the walkway 66 are a plank 68 and two support members 70. The support members 70 are of adjustable length. As shown in FIG. 9, a single support member 70 can be positioned alongside the cart 10, and the plank 68 extended from the cart 10 to the support member 70 so as to provide an extended walkway/scaffold combination.

Referring now to FIG. 10, it can be seen that the frames 46 can be used to form a ladder. In the embodiment shown in FIG. 10, the frames 46 are joined at top portions thereof with a joining member 71, so as to form a substantially A-shaped ladder. While the ladder in FIG. 10 is formed from two frames 46, it would be possible to form a ladder from, for example, four frames 46, with each side of the ladder comprising two frames 46 joined by coupling devices 48. It would also be possible to form a standard ladder from one or more frames 46, of the type that can be simply leaned against a structure—such as a wall or tree—that is to be climbed. As shown in FIG. 10, length adjusting members 73 may be coupled to bottom portions of the frames 46, so as to make the ladder formed herein adjustable in height.

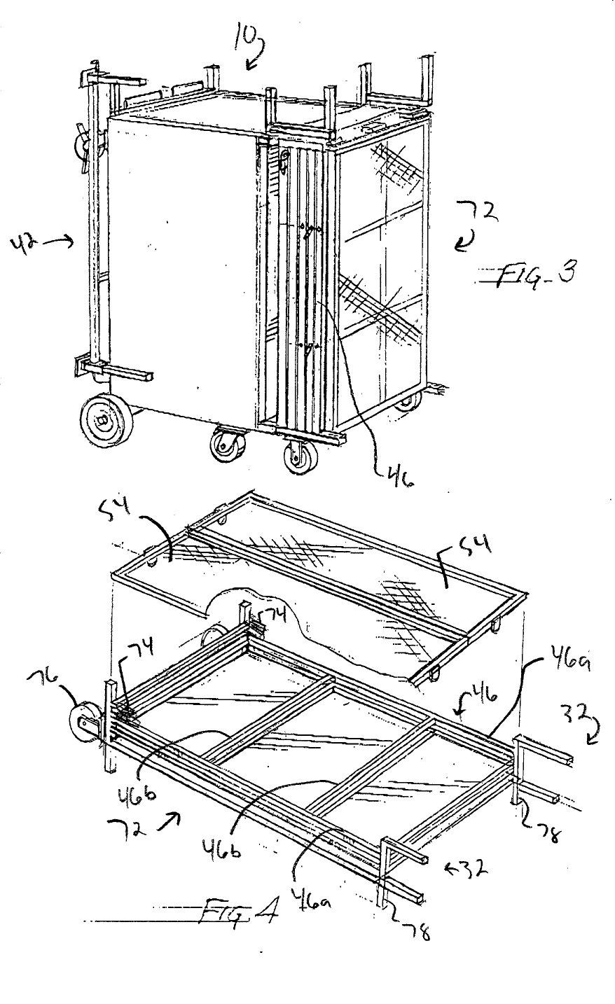

Referring now to FIGS. 3 and 4, the storage of the cart 10 and the components disclosed herein is shown. Referring first to FIG. 4, the frames 46 may be positioned on a frame storage cart 72. The frame storage cart 72 has insertion shafts 74 at an end thereof, over which are inserted ends of the vertical member portions of the frame 46. At one end of the frame storage cart 72 are wheels 76. At the opposing end of the frame storage cart 72 may be inserted Y-shaped brackets 32. The Y-shaped brackets 32 may be grasped by a user and used to raise that end of the frame storage cart 72, so that it may be wheeled upon wheels 76. The steps 54 may be positioned over the frames 46 when the frames 46 are in position on the frame storage cart 72, so as to create a series of covered compartments which may be used for storage.

The frame storage cart 72 may be coupled to the cart 10, as shown in FIG. 3, by inserting insertion shafts 78 located at the four corners of the base of the frame storage cart 72 into the receiving shafts 25 on the cart 10. The frame storage cart 72 may be secured to the cart 10 with BUNGEE® cords (not shown), chains (not shown), or the like. The entire apparatus may then be placed in the bed of a pickup-type truck. Alternatively, a trailer assembly may be affixed to the cart 10, permitting it to be towed by a vehicle having a receiver hitch.

Before the cart 10 is configured for transport, the individual components discussed herein and not illustrated as being coupled to the exterior of the cart 10—with the sole exception of the plank 68—may be stowed within the cart 10 or the frame storage cart 72. Additionally, the outriggers 42 may be coupled along the sides of the cart 10 as shown in FIG. 3, by coupling the outriggers 42 to insertion shafts (not shown) located below the base 12 of the cart 10.

While the invention has been particularly shown and described with reference to preferred embodiments thereof, it will be understood by those skilled in the art that the foregoing and other changes in form and details may be made therein without departing from the spirit and scope of the invention. While the cart 10 has been discussed with respect to its possible construction applications, it should be understood that the cart 10 could be useable for a large variety of uses. This would include, for example, the installation of Christmas lights, painting, trimming of trees, swap meet displays, etc.

I claim:

1. A multiple function work cart comprising, in combination:
a cart having a base and two opposing side walls coupled at a right angle to said base so as to form an essentially U-shaped structure when viewed from an end thereof having two open ends;
wheels coupled to said cart; and
dividers adapted to be removably coupled to at least one of said open ends.

2. The multiple function work cart of claim 1 further comprising means for removably coupling handles to said cart.

3. The multiple function work cart of claim 1 wherein said wheels comprise two wheels located proximate a first end of said base, two wheels located proximate a second end of said base, and one wheel located proximate a top portion of each said side wall so that said cart may optionally be rolled in each of a horizontal and vertical configuration.

4. The multiple function work cart of claim 1 further comprising a door adapted to be hingedly coupled to one of said side walls opposite said base.

5. The multiple function work cart of claim 1 further comprising at least one ladder-shaped frame member comprising two vertical members joined by at least one horizontal member and wherein an end portion of said vertical members is adapted to be removably coupled to said cart proximate corner portions of said side walls.

6. The multiple function work cart of claim 5 further comprising at least two said ladder-shaped frame members.

7. The multiple function work cart of claim 6 further comprising at least one step adapted to be positioned across said horizontal members of said two ladder-shaped frame members when in position on opposing ends of said cart.

8. The multiple function work cart of claim 7 further comprising a coupling member adapted to permit the coupling of two ladder-shaped frame members in a vertical direction so that one said ladder-shaped frame member is positioned directly on top of another.

9. The multiple function work cart of claim 7 further comprising a stabilizing bar adapted to be positioned across said vertical members of said two ladder-shaped frame members when in position on opposing ends of said cart.

10. The multiple function work cart of claim 7 further comprising a rectangular-shaped mini-step adapted to be positioned across said vertical members of said two ladder-shaped frame members when in position on opposing ends of said cart, with said rectangular-shaped mini-step being positioned at a ninety degree angle relative to said step.

11. The multiple function work cart of claim 7 further comprising at least two substantially Y-shaped brackets each adapted to be inserted into an open end of said vertical members of said ladder-shaped frame members.

12. The multiple function work cart of claim 7 further comprising at least one outrigger, adapted to be removably coupled to said cart proximate an end thereof at an angle that is perpendicular to said side walls, so as to impart increased stability to said cart.

13. The multiple function work cart of claim 11 further comprising a bar adapted to be positioned across said Y-shaped brackets, said bar being adapted to have coupled thereto a sheet-type material.

14. The multiple function work cart of claim 7 further comprising a plank capable of being positioned upon each of said cart and a support member positioned remote from said cart.

15. The multiple function work cart of claim 6 further comprising a joining member adapted to couple said two frame members in a substantially A-shape so as to form a ladder.

16. The multiple function work cart of claim 6 further comprising means for adjusting a length of each said two frame members.

17. The multiple function work cart of claim 1 further comprising means for coupling dividers at each of said open ends and at least one other point that is parallel and between said open ends.

18. The multiple function work cart of claim 6 further comprising a frame storage cart adapted to receive thereon said at least two ladder-shaped frames and wherein said frame storage cart is adapted to be removably coupled to said cart.

19. A multiple function work cart comprising, in combination:
a cart having a base and two opposing side walls coupled at a right angle to said base so as to form an essentially U-shaped structure when viewed from an end thereof having two open ends;
wheels coupled to said cart;
wherein said wheels comprise two wheels located proximate a first end of said base, two wheels located proximate a second end of said base, and one wheel located proximate a top portion of each said side wall so that said cart may optionally be rolled in each of a horizontal and vertical configuration;
dividers adapted to be removably coupled to at least one of said open ends;
means for removably coupling handles to said cart;
a door adapted to be hingedly coupled to one of said side walls opposite said base;
at least two ladder-shaped frame member comprising two vertical members joined by at least one horizontal member and wherein an end portion of said vertical members is adapted to be removably coupled to said cart proximate corner portions of said side walls;
at least one step adapted to be positioned across said horizontal members of said two ladder-shaped frame members when in position on opposing ends of said cart; and
a coupling member adapted to permit the coupling of two ladder-shaped frame members in a vertical direction so that one said ladder-shaped frame member is positioned directly on top of another.

20. A multiple function work cart comprising, in combination:
a cart having a base and two opposing side walls coupled at a right angle to said base so as to form an essentially U-shaped structure when viewed from an end thereof;
two wheels located proximate a first end of said base;
two wheels located proximate a second end of said base; and
one wheel located proximate a top portion of each said side wall so that said cart may optionally be rolled in each of a horizontal and vertical configuration.
